(19) United States
(12) Patent Application Publication
(10) Pub. No.: US 2008/0252564 A1
(43) Pub. Date: Oct. 16, 2008

(54) Plasma display panel and method of driving the same

(76) Inventors: In-Ju Choi, Suwon-si (KR); Woo-Joon Chung, Suwon-si (KR); Seong-Joon Jeong, Suwon-si (KR); Tae-Seong Kim, Suwon-si (KR)

Correspondence Address: ROBERT E. BUSHNELL, 1522 K STREET NW, SUITE 300, WASHINGTON, DC, 20005-1202, US

(21) Appl. No.: 12/081,299

(22) Filed: Apr. 14, 2008

(30) Foreign Application Priority Data
Apr. 12, 2007 (KR) 10-2007-0036179

(51) Int. Cl. G09G 3/28

(52) U.S. Cl. 345/67; 345/60

(57) ABSTRACT

Provided is a method of driving a plasma display panel (PDP) that comprises X electrodes, Y electrodes, and address electrodes, wherein a frame, which is a display cycle, comprises a plurality of subfields for time-divisional gray scale display. Each of the subfields includes a reset period, an address period, and a sustain period. The reset period is one of a main reset period during which both a rising pulse and a falling pulse are applied to the Y electrodes and an auxiliary reset period during which one of the rising pulse and the falling pulse is applied to the Y electrodes, and the main reset period comprises a first pulse time during which a pulse rising to a level of a first voltage and then falling to a level of a second voltage is applied to the Y electrodes and a second pulse time during which a pulse rising to a level of a third voltage and then falling to a level of a fourth voltage is applied to the Y electrodes.

### CLAIM OF PRIORITY

This application makes reference to, incorporates the same herein, and claims all benefits accruing under 35 U.S.C. §119 from an application earlier filed in the Korean Intellectual Property Office on the 12 Apr. 2007 and there duly assigned Serial No. 10-2007-0036179.

### BACKGROUND OF THE INVENTION

1. Field of the Invention

The present invention relates to a plasma display panel (PDP) and a method of driving the PDP, and more particularly, to a PDP capable of reducing the generation of an erroneous discharge and a method of driving the PDP.

2. Description of the Related Art

PDPs, which have become popular as large-size flat display panels, are devices that display desired images by applying a discharge voltage to a discharge gas between two substrates with a plurality of electrodes formed on the substrates so as to generate ultraviolet (UV) rays, and exciting a patterned phosphor material with the UV rays.

In general, a PDP is driven according to a unit frame, which is a display cycle divided into a plurality of subfields, and a gray scale is represented by a combination of subfields. Each of the sub fields includes a reset period, an address period, and a sustain period. During a reset period, wall charges formed by a sustain discharge generated during a previous period are erased, and wall charges are set up in order to perform the next address discharge. During an address period, cells of the PDP that are to be turned on are discriminated from cells that are to be turned off, and wall charges are accumulated on the to-be-turned-on cells (i.e., addressed cells). During a sustain period, a sustain discharge for actually displaying an image on the addressed cells is performed.

During a reset period of each subfield, a rising ramp portion of a reset pulse is applied to Y electrodes in order to thereby generate a weak discharge, and a falling ramp portion of the reset pulse is then applied to the Y electrodes in order to equalize the wall charge conditions of all of the cells of the PDP. However, no sustain discharge is generated in cells that were not selected in the previous subfield, so that the wall charge states of the unselected cells set up during the reset period of the previous subfield are kept. In other words, there is no need to re-accumulate wall charges during the reset period of the current subfield by applying a rising ramp portion.

Hence, a main reset pulse having both a rising ramp portion and a falling ramp portion may be applied during the reset period of a first subfield, and then an auxiliary reset pulse having either a rising ramp portion or a falling ramp portion may be applied during the reset periods of a predetermined number of subfields other than the first subfield.

However, a strong discharge is caused by a relatively large number of priming particles that are generated during a main reset period when a rapid pattern change occurs, so that an erroneous discharge, in which a sustain discharge occurs even when no data is applied during an address period, may occur. Moreover, in a low-gray-level subfield, an erroneous discharge is generated during a reset period, and thus even when data is applied to discharge cells during an address period, the corresponding discharge cells are not turned on, so that no discharge is generated during a sustain period, resulting in a low discharge. Some of the discharge cells turned on during the current subfield do not undergo discharge during a sustain period of the current subfield, but instead, the sustain discharge occurs in the next subfield, so that a low-gray-level erroneous discharge is generated.

### SUMMARY OF THE INVENTION

The present invention provides a plasma display panel (PDP) capable of preventing the generation of an undesired discharge by removing an error that may be generated during a reset operation and also a PDP capable of preventing a low discharge and an erroneous discharge in low-gray-level subfields, and a method of driving the PDP.

According to an aspect of the present invention, there is provided a method of driving a plasma display panel (PDP), which comprises X electrodes, Y electrodes, address electrodes, and discharge cells to generate light. The method includes steps of applying a main reset pulse to the Y electrodes during a main reset period of a subfield to reset the discharge cells, applying an address data signal to the address electrodes during an address period to select discharge cells to be turned on, and alternatively applying a sustain pulse to the X electrodes and to the Y electrodes during a sustain period to generate a sustain discharge in the selected discharge cells. The step of applying the main reset pulse further includes steps of applying a pulse rising to a level of a first voltage and then falling to a level of a second voltage during a first pulse time period, and applying a pulse rising to a level of a third voltage and then falling to a level of a fourth voltage during a second pulse time period. The first voltage may be lower than the third voltage.

The step of applying the main reset pulse may further include applying a pulse falling to a level of a fifth voltage during a preset time period that is included in the main reset period. The magnitude of the fifth voltage may be substantially the same as the magnitude of the fourth voltage.

The step of applying a pulse rising to the level of the first voltage and then falling to the level of the second voltage may include applying a pulse rising to the level of the first voltage from a level of a reference voltage. The step of applying a pulse rising to the level of the first voltage and then falling to the level of the second voltage may include applying a pulse falling to the level of the second voltage from the level of the reference voltage. The step of applying a pulse rising to the level of the third voltage and then falling to the level of the fourth voltage may include applying a pulse rising to the level of the third voltage from a level of a sixth voltage. The step of applying a pulse rising to the level of the third voltage and then falling to the level of the fourth voltage may include applying the pulse falling to the level of the fourth voltage from the level of the reference voltage.

The method may further include a step of applying an auxiliary reset pulse to the Y electrodes during an auxiliary reset period of another subfield to reset the discharge cells. A maximum voltage of the auxiliary reset pulse may be lower than the third voltage.

The step of applying the auxiliary reset pulse may include a step of applying a pulse rising to a level of a first auxiliary voltage, or a step of applying a pulse falling to a level of a second auxiliary voltage.

The method of driving a PDP may further include steps of applying a reference voltage to the address electrodes during the main reset period, and applying a seventh voltage to the X electrodes while applying a pulse falling to the level of the fourth voltage to the Y electrodes during the second pulse time period.

The method driving a PDP may further include applying a seventh voltage to the X electrodes during the address period, applying a selection pulse having a ninth voltage to the Y electrodes during a selection time that is included in the address period, and applying an eighth voltage to the Y electrodes during a portion of the address period that is not included in the selection time. The address data signal includes a data pulse having a reference voltage or a tenth voltage, the phase of the data pulse synchronizing with the phase of the selection pulse.

The method driving a PDP may further include applying a reference voltage to the address electrodes during the sustain period. The sustain pulse has the first voltage.

According to another aspect of the present invention, there is provided a plasma display panel device including a plasma display panel and a panel driving unit applying a set of driving signals to the plasma display panel to drive the plasma display panel. The plasma display panel includes a first substrate, a second substrate facing the first substrate, X electrodes and Y electrodes disposed between the first substrate and the second substrate, and address electrodes disposed between the first substrate and the second substrate. The address electrodes cross the X and Y electrodes, and discharge cells are formed at intersections of the address electrodes with the X and Y electrodes. The set of the driving signals includes a main reset pulse applied to the Y electrodes during a main reset period of a subfield to reset the discharge cells, an address data signal applied to the address electrodes during an address period to select discharge cells to be turned on, and a sustain pulse alternately applied to the X electrodes and to the Y electrodes during a sustain period to generate a sustain discharge in the selected discharge cells. The main reset pulse includes a first pulse rising to a level of a first voltage and then falling a level of a second voltage during a first pulse time period, and a second pulse rising to a level of a third voltage and then falling to a level of a fourth voltage during a second pulse time period. The first voltage is lower than the third voltage.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 is a perspective view of a structure of a plasma display panel (PDP) that may be driven using a method according to the present invention;

FIG. 2 is a cross-section of a unit display cell of the PDP illustrated in FIG. 1;

FIG. 3 is a schematic diagram of a configuration of electrodes of the PDP illustrated in FIG. 1;

FIG. 4 is a schematic block diagram of a plasma display panel device that includes an apparatus for driving the PDP illustrated in FIG. 1;

FIG. 5 is a timing diagram illustrating a method of driving the PDP illustrated in FIG.

FIG. 6 is a timing diagram illustrating driving signals applied to electrodes in a PDP driving method according to an embodiment of the present invention; and

FIG. 7 is a timing diagram illustrating driving signals applied to electrodes in a PDP driving method according to another embodiment of the present invention.

### DETAILED DESCRIPTION OF THE INVENTION

The present invention will now be described more fully with reference to the accompanying drawings, in which exemplary embodiments of the invention are shown.

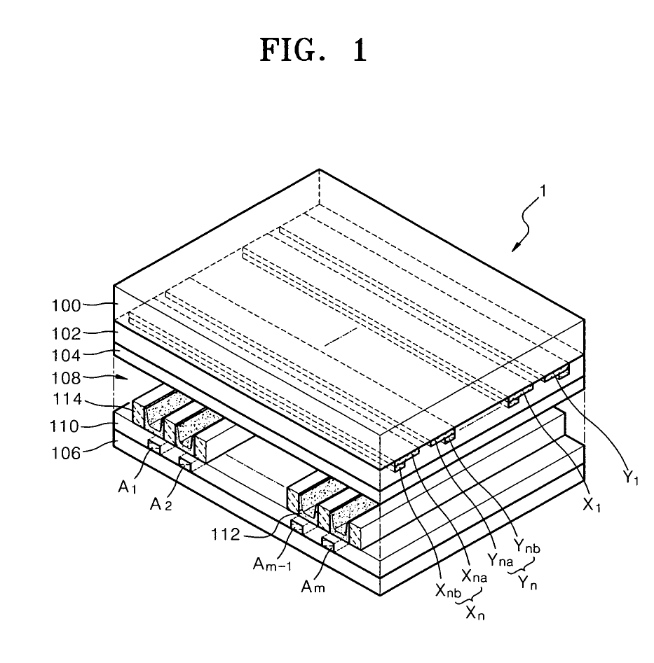

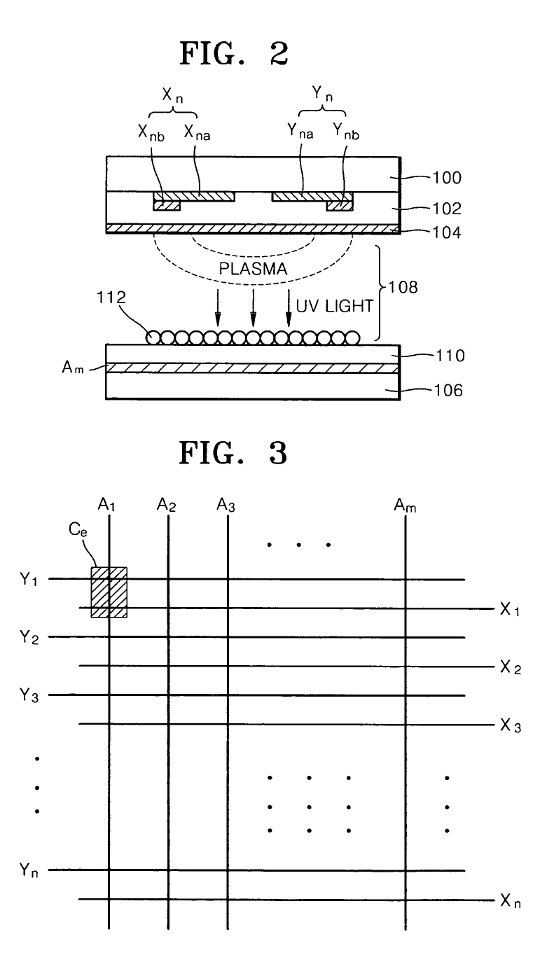

FIG. 1 is a perspective view of a structure of a plasma display panel (PDP) 1 that is driven using a method according to an embodiment of the present invention. FIG. 2 is a cross-section of a unit display cell of the PDP 1 illustrated in FIG. 1.

Referring to FIG. 1 and FIG. 2, A electrodes (i.e., address electrodes) A1 through Am, first and second dielectric layers 102 and 110, Y electrodes Y1 through Yn, X electrodes X1 through Xn, phosphor layers 112, barrier ribs 114, and a MgO protection layer 104 are included between a first substrate 100 and a second substrate 106.

The A electrodes A1 through Am are arranged in a predetermined pattern on the second substrate 106. The second dielectric layer 110 covers the A electrodes A1 through Am. The barrier ribs 114 are formed parallel to the A electrodes A1 through Am on the second dielectric layer 110. The barrier ribs 114 define discharge areas of discharge cells and prevent optical interference between discharge cells. The phosphor layers 112 include red phosphor layers, green phosphor layers, and blue phosphor layers that are arranged on portions of the second dielectric layer 110 that cover the A electrodes A1 through Am between the barrier ribs 114. A red phosphor layer, a green phosphor layer, and a blue phosphor layer are sequentially arranged, and this configuration repeats.

The X electrodes X1 through Xn and the Y electrodes Y1 through Yn are arranged in a pattern on the first substrate 100 so as to intersect the A electrodes A1 through Am. The intersections establish corresponding discharge cells. Each of the X electrodes X1 through Xn, for example, Xn, may include a transparent electrode Xna formed of a transparent conductive material, such as Indium Tin Oxide (ITO), and a metal electrode Xnb for increasing conductivity. Each of the Y electrodes Y1 through Yn, for example, Yn, may include a transparent electrode Yna formed of a transparent conductive material, such as ITO, and a metal electrode Ynb for increasing conductivity. The first dielectric layer 102 is formed on the entire surface of the first substrate 100 so as to cover the X electrodes XI through Xn and the Y electrodes Y1 through Yn. The protection layer 104, such as, a MgO layer, protecting the PDP 1 from a strong electrical field, is formed on the entire surface of the first dielectric layer 102. A discharge space 108 is filled with a gas for forming plasma.

A PDP, which is driven by a driving apparatus of the present invention, is not limited to the PDP 1 illustrated in FIG. 1. In other words, the PDP which is driven by the driving apparatus of the present invention may be a two-electrode PDP including only two kinds of electrodes instead of a three-electrode PDP as illustrated in FIG. 1. In addition, PDPs having other various structures may be used, and any PDP is sufficient as long as it is driven using a driving method according to an embodiment of the present invention.

FIG. 3 is a schematic diagram of a configuration of electrodes of the PDP 1 illustrated in FIG. 1. Referring to FIG. 3, the Y electrodes Y1 through Yn and the X electrodes X1 through Xn are arranged in parallel to each other, and the A electrodes A1 through Am intersect the Y electrodes Y1 through Yn and the X electrodes X1 through Xn. Areas where the Y electrodes Y1 through Yn and the X electrodes X1 through Xn intersect the A electrodes A1 through Am correspond to discharge cells Ce.

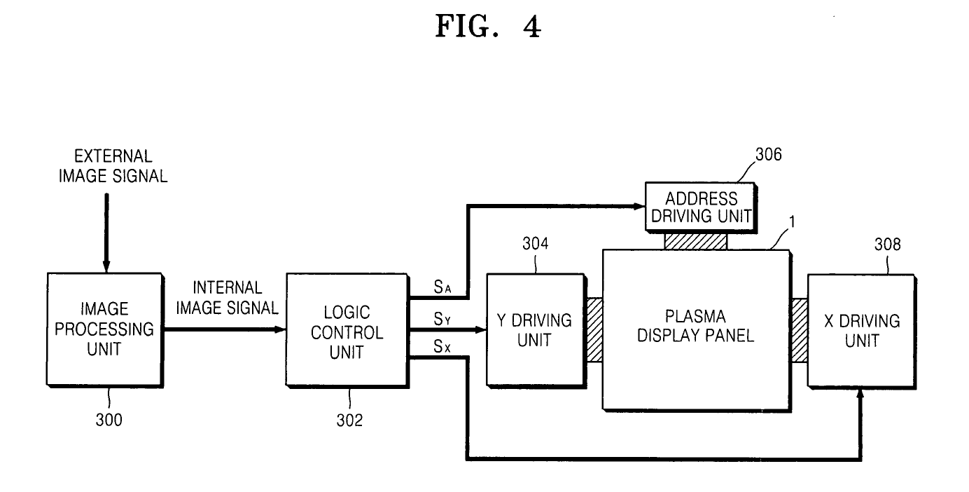

FIG. 4 is a schematic block diagram of a plasma display panel device that includes an apparatus for driving the PDP 1 illustrated in FIG. 1. Referring to FIG. 4, the apparatus for driving the PDP 1 includes an image processing unit 300, a control unit 302, an address driving unit 306, an X driving unit 308, and a Y driving unit 304. The image processing unit 300 generates internal image signals, for example, 8-bit red (R) image data, 8-bit green (G) image data, 8-bit blue (B) image data, a clock signal, a vertical synchronization signal, and a horizontal synchronization signal, by converting an external analog image signal into a digital signal. The control unit 302 generates driving control signals, namely, an address signal SA, a Y driving control signal SY, and an X driving control signal SX, according to the internal image signals of the image processing unit 300. The address driving unit 306 generates a display data signal by processing the address signal SA from among the driving control signals SA, SY, and SX output by the control unit 302 and applies the display data signal to address electrode lines. The X driving unit 308 processes the X driving control signal SX from among the driving control signals SA, SY, and SX output by the control unit 302 and applies the X driving control signal SX to X electrode lines. The Y driving unit 304 processes the Y driving control signal SY from among the driving control signals SA, SY, and SX output by the control unit 302 and applies the Y driving control signal SY to Y electrode lines.

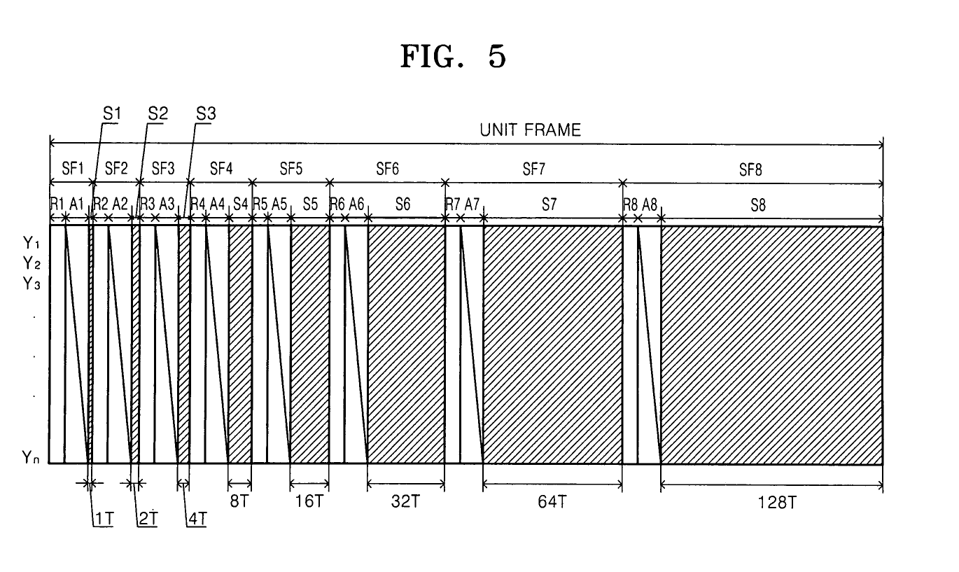

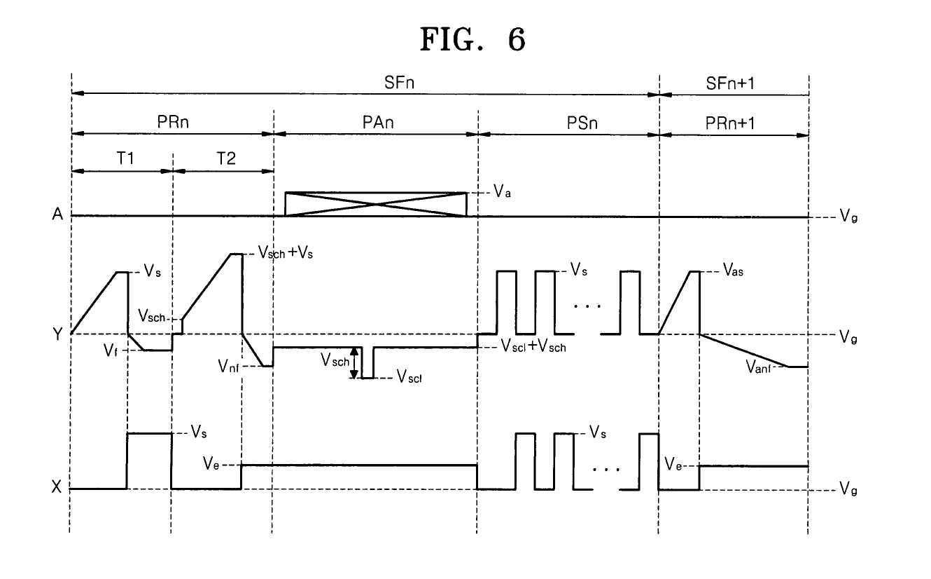

FIG. 5 is a diagram illustrating a method of driving the PDP 1 illustrated in FIG. 1. Referring to FIG. 5, a unit frame may be divided into a predetermined number of subfields, for example, 8 subfields SF1 through SF8, in order to accomplish time-divisional gray scale display. The subfields SF1 through SF8 are divided into reset periods R1 through R8, respectively, address periods A1 through A8, respectively, and sustain periods S1 through S8, respectively.

During each of the reset periods R1 through R8, a reset pulse is applied to the Y electrodes Y1 through Yn, and thus wall charge conditions for all cells are equalized, so that all of the cells are initialized.

During each of the address periods A1 through A8, an address pulse is applied to the A electrodes, and simultaneously, corresponding scan pulses are sequentially applied to the Y electrodes Y1 through Yn.

During each of the sustain periods S1 through S8, sustain pulses are alternately applied to the Y electrodes Y1 through Yn and the X electrodes X1 through Xn, so that a sustain discharge is generated in discharge cells where wall charges are formed during the address periods A1 through A8.

The brightness of a PDP is proportional to the number of sustain discharge pulses applied during the sustain periods S1 through S8 included in a unit frame. For example, when one frame in which one image is formed is represented as 8 subfields and 256 gray scales, different numbers of sustain pulses may be allocated to the 8 subfields in the ratio of 1:2:4:8:16:32:64:128, respectively. For example, in order to obtain a brightness with a 133 gray scale, discharge cells are addressed during the first subfield SF1, the third subfield SF3, and the eighth subfield SF8, and a sustain discharge is performed.

The number of sustain pulses allocated to each subfield may vary according to the weight of each subfield depending on an automatic power control (APC) stage. The number of sustain pulses allocated to each subfield may also vary in consideration of gamma characteristics or panel characteristics. For example, a gray scale allocated to the fourth subfield SF4 may be lowered from 8 to 6, and a gray scale allocated to the sixth subfield SF6 may be increased from 32 to 34. In addition, the number of subfields that constitute one frame may vary according to design.

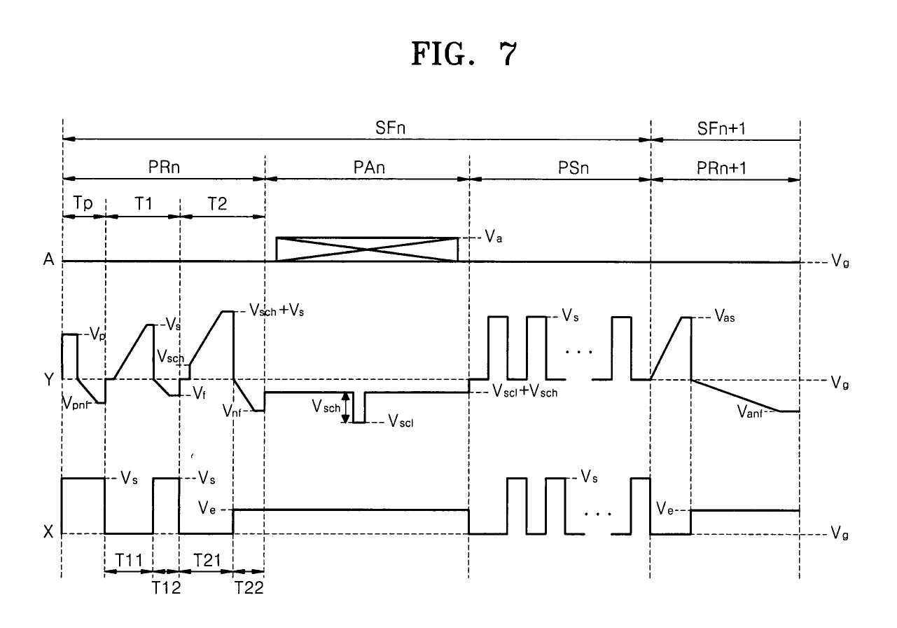

FIG. 6 illustrates time dependent driving signals applied to electrodes according to a PDP driving method of an embodiment of the present invention. Referring to FIG. 6, a unit frame for driving the PDP 1 is divided into a plurality of subfields SF, each of which has a reset period PR, an address period PA, and a sustain period PS. The reset period PR is either a main reset period, during which a main reset pulse that includes both a rising pulse (a first pulse) and a falling pulse (a second pulse) are applied to the Y electrodes Y1 through Yn, or an auxiliary reset period, during which either a rising pulse (a first auxiliary pulse) or a falling pulse (a second auxiliary pulse) is applied to the Y electrodes Y1 through Yn.

A reset period PRn of a subfield SFn is a main reset period. The main reset period includes a first pulse time period T1 and a second pulse time period T2. During the first pulse time period T1, a pulse, which rises to the level of a first voltage Vs and then falls to the level of a second voltage Vf, is applied to the Y electrodes Y1 through Yn after the last sustain pulse applied during the previous sustain period. For example, a voltage having a rising ramp from the level of a reference voltage Vg to the level of the first voltage Vs is applied to the Y electrodes Y1 through Yn, and then a voltage having a falling ramp from the level of the reference voltage Vg to the level of the second voltage Vf is applied to the Y electrodes Y1 through Yn.

During the second pulse time period T2, a pulse, which rises to the level of a third voltage Vsch+Vset and then falls to the level of a fourth voltage Vnf, is applied to the Y electrodes Y1 through Yn. For example, a voltage having a rising ramp from the level of a sixth voltage Vsch to the level of the third voltage Vsch+Vset is applied to the Y electrodes Y1 through Yn, and a voltage having a falling ramp from the level of the reference voltage Vg to the level of the fourth voltage Vnf is applied to the Y electrodes Y1 through Yn.

During the main reset period PRn, the reference voltage Vg is applied to the address electrodes A1 through Am. When a rising ramp voltage is applied to the Y electrodes Y1 through Yn, the reference voltage Vg is applied to the X electrodes X1 through Xn. When a falling ramp voltage is applied to the Y electrodes Y1 through Yn, a seventh voltage Ve may be applied to the X electrodes X1 through Xn.

While the rising ramp voltage is being applied, a weak discharge is generated along the direction of the Y electrodes Y1 through Yn to the address electrodes A1 through Am and the X electrodes X1 through Xn. Due to this weak discharge, negative wall charges are accumulated on the Y electrodes Y1 through Yn, and positive wall charges are accumulated on the address electrodes A1 through Am and the X electrodes X1 through Xn.

While the falling ramp voltage is being applied, a weak discharge is generated along the direction of the address electrodes A1 through Am and the X electrodes X1 through Xn to the Y electrodes Y1 through Yn due to a wall voltage formed in the discharge cells. Due to this weak discharge, wall charges formed on the X electrodes X1 through Xn, the Y electrodes Y 1 through Yn, and the address electrodes A1 through Am are partially erased, so that the discharge cells are set to have states suitable for undergoing addressing.

However, when the turned-on states of discharge cells are abruptly changed to turned-off states like when a pattern change occurs, a relatively large number of priming particles are generated during a reset period. Due to the priming particles, a strong discharge instead of a weak discharge may be generated when a rising ramp voltage and a falling ramp voltage are applied during the reset period. In this case, even when no data pulses are applied during an address period, an erroneous discharge is generated during a sustain period. In particular, when the temperature of a panel, which underwent an aging for a long time, dropped to a low temperature, a discharge initiation voltage also dropped. In this case, the frequency of erroneous discharge generation caused by the strong discharge generated in the reset period was significantly increased.

In order to control the priming particles that cause erroneous discharge, a reset pulse is used twice in a row during a main reset period in an embodiment of the present invention. A stable weak discharge condition is created by inducing a discharge from the first reset pulse and generating the priming particles. By applying the second reset pulse, a strong discharge is suppressed, and a proper reset operation can be executed.

According to an embodiment of the present invention, low-gray-level low discharge and low-gray-level erroneous discharge, which are capable of being generated on discharge cells that keep on states, can be reduced. In other words, in a conventional technique, low-gray-level low discharge occurs, and even when a data pulse is applied during an address period, an addressing operation is not properly performed because of an erroneous discharge generated during a reset period prior to the address period, and a discharge is not generated during a sustain period. Moreover, in the conventional technique, low-gray-level erroneous discharge occurs, and some of the discharge cells that maintain on states undergo discharge during the sustain period of the next subfield. However, the use of two reset pulses according to an embodiment of the present invention contributes to a stable reset operation, so that a low discharge and erroneous discharge generated at a low gray scale can be prevented.

The first voltage Vs is preferably lower than the third voltage Vsch+Vset. The second voltage Vf is preferably higher than the fourth voltage Vnf. In other words, the rising top level voltage of a first reset pulse of the two reset pulses is preferably lower than the rising top level voltage of a second reset pulse, and the falling bottom level voltage of the first reset pulse of the two reset pulses is preferably higher than the falling bottom level voltage of the second reset pulse.

When two reset pulses having an identical size are used, a problem may arise in that background brightness increases compared with a conventional technique. This problem can be solved by controlling the relative sizes of the voltages as described above.

During an address period PAn, discharge cells in which a sustain discharge is to occur during a sustain period PSn are selected. During the address period PAn, the seventh voltage Ve is continuously applied to the X electrodes X1 through Xn, scan pulses are sequentially applied to the Y electrodes Y1 through Yn, and a display data signal is applied to the address electrodes A1 through Am in synchronization with the scan pulses so that an address discharge is executed. Each of the scan pulses first has an eighth voltage Vscl+Vsch and then has a ninth voltage Vscl that is lower than the eighth voltage Vscl+Vsch. The display data signal (or address data signal) has a positive tenth voltage Va synchronized with an application of the ninth voltage Vscl of a scan pulse.

In other words, a selection pulse having a ninth voltage is applied to the Y electrodes during the address period. The selection pulse has a finite pulse width that is defined as a selection time. The eighth voltage is applied to the Y electrodes during the rest of the address period except the selection time. The display data signal has data pulses having the tenth voltage Va or the reference voltage. Some of the data pulses may have the tenth voltage and the other data pulses may have the reference voltage. The display data signal is applied to the address electrodes during the address period. The phase of the data pulses synchronizes with the phase of the selection pulse, and therefore, address discharge occurs under the combination of the display data signal applied to the address electrodes and the synchronized selection pulse applied to the Y electrodes.

In the discharge cells selected during the address period PAn, a sustain discharge is generated by a sustain pulse applied during a sustain period. On the other hand, in discharge cells that were not selected during the address period PAn, sustain discharge is not generated even when a sustain pulse is applied during the sustain period.

During a sustain period PSn, sustain pulses are alternately applied to the X electrodes X1 through Xn and the Y electrodes Y1 through Yn, so that a sustain discharge is performed. The brightness of a unit field comprised of a plurality of subfields is displayed by the execution of sustain discharges depending on gray scale weights allocated to the subfields. The sustain pulses alternate between the level of the first voltage Vs and the level of the reference voltage Vg.

A reset period PRn+1 of the next subfield SFn+1 is an auxiliary reset period. During the auxiliary reset period PRn+1, either a rising pulse (a first auxiliary pulse) or a falling pulse (a second auxiliary pulse) is applied to the Y electrodes Y1 through Yn.

Alternatively, both a rising pulse having a rising top level voltage lower than the rising top level voltage of a main reset pulse for a main reset period and a falling pulse may be applied during the auxiliary reset period. For example, referring to FIG. 6, both a voltage having a rising ramp from the reference voltage Vg to a first auxiliary voltage Vas and a voltage having a falling ramp from the level of the reference voltage Vg to a level of a second auxiliary voltage Vanf may be applied during the auxiliary reset period PRn+1. The level of the first auxiliary voltage Vas can be the same as the level of the first voltage Vs, and the level of the second auxiliary voltage Vanf can be the same as the level of the fourth voltage Vnf. In this case, similar to when the main reset pulse is applied, the reference voltage Vg is applied to the address electrodes A1 through Am. When a rising ramp voltage is applied to the Y electrodes Y1 through Yn, the reference voltage Vg may be applied to the X electrodes X1 through Xn. When a falling ramp voltage is applied to the Y electrodes Y1 through Yn, the seventh voltage Ve may be applied to the X electrodes X1 through Xn.

An address period (not shown) and a sustain period (not shown) of a subfield SFn+1 may be the same as the address period PAn and the sustain period PSn of the subfield SFn.

A combination of main reset periods and auxiliary reset periods in a frame is not limited to any particular one. However, it is desirable that a first subfield of a frame includes a main reset period and the other subfields of the frame include auxiliary reset periods.

FIG. 7 is a time dependent driving signals applied to electrodes in a PDP according to the driving method of another embodiment of the present invention. Referring to FIG. 7, driving signals in an address period and a sustain period of FIG. 7 are the same as those of the address period and sustain period of FIG. 6 except that a main reset period PRn illustrated in FIG. 7 further includes a preset time period Tp. The main reset period PRn includes the preset time period Tp, a first pulse time period T1, and a second pulse time period T2.

During the preset time period Tp, a ramp pulse (a preset pulse) falling from the level of the reference voltage Vg to a level of a fifth voltage Vpnf is applied to the Y electrodes Y1 through Yn, the first voltage Vs is applied to the X electrodes X1 through Xn, and the reference voltage Vg is applied to the A electrodes A1 through Am. The level of the fifth voltage Vpnf can be the same as the level of the fourth voltage Vaf.

The first pulse time period T1 includes a first rising ramp pulse time period T11 and a first falling ramp pulse time period T12. During the first rising ramp pulse time period T11, a voltage having a rising ramp pulse waveform is applied to the Y electrodes Y1 through Yn. During the first falling ramp pulse time period T12, a voltage having a falling ramp pulse waveform is applied to the Y electrodes Y1 through Yn.

The second pulse time period T2 includes a second rising ramp pulse time period T21 and a second falling ramp pulse time period T22. During the second rising ramp pulse time period T21, a voltage having a rising ramp pulse waveform is applied to the Y electrodes Y1 through Yn. During the second falling ramp pulse time period T22, a voltage having a falling ramp pulse waveform is applied to the Y electrodes Y1 through Yn.

The preset time period Tp is set to create a sufficient number of wall charges so that a discharge can occur during the first rising ramp pulse time period T11 of the first pulse time period T1. In other words, in the embodiment illustrated in FIG. 7, the main reset period PRn further includes the preset time period Tp so that a weak discharge suitable for an address discharge subsequent to the first and second pulse time period periods T1 and T2 can easily occur.

The second rising ramp pulse time period T21 of the second pulse time period T2 is set to accumulate wall charges due to a weak discharge. The second falling ramp pulse time period T22 of the second pulse time period T2 is set so that the wall charges accumulated during the second rising ramp pulse time period T21 of the second pulse time period T2 are erased due to a weak discharge so as to be suitable for the address period PAn subsequent to the main reset period PRn.

The first rising ramp pulse time period T11 and the first falling ramp pulse time period T12 of the first pulse time period T1 are prepared so that a strong discharge may not occur during the second rising ramp pulse time period T21 and the second falling ramp pulse time period T22 of the second pulse time period T2.

According to the present invention, even in a situation where discharge cells abruptly change from an on state to an off state, a weak discharge is induced during a reset period, so that an erroneous discharge can be prevented from occurring during a sustain period. A low discharge and an erroneous discharge in low-gray-level subfields can also be prevented from occurring in discharge cells that maintain an on state.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of driving a plasma display panel, which comprises X electrodes, Y electrodes, address electrodes, and discharge cells to generate light, the method comprising:
applying a main reset pulse to the Y electrodes during a main reset period of a subfield to reset the discharge cells, the step of applying the main reset pulse comprising:
applying a pulse rising to a level of a first voltage and then falling to a level of a second voltage during a first pulse time period; and
applying a pulse rising to a level of a third voltage and then falling to a level of a fourth voltage during a second pulse time period, the first voltage being lower than the third voltage;
applying an address data signal to the address electrodes during an address period to select discharge cells to be turned on; and
alternatively applying a sustain pulse to the X electrodes and to the Y electrodes during a sustain period to generate a sustain discharge in the selected discharge cells.

2. The method of claim 1, wherein the step of applying the main reset pulse further including:
applying a pulse falling to a level of a fifth voltage during a preset time period that is included in the main reset period.

3. The method of claim 2, wherein the magnitude of the fifth voltage is substantially the same as the magnitude of the fourth voltage.

4. The method of claim 1, wherein:
the step of applying a pulse rising to the level of the first voltage and then falling to the level of the second voltage includes applying a pulse rising to the level of the first voltage from a level of a reference voltage;
the step of applying a pulse rising to the level of the first voltage and then falling to the level of the second voltage includes applying a pulse falling to the level of the second voltage from the level of the reference voltage;
the step of applying a pulse rising to the level of the third voltage and then falling to the level of the fourth voltage includes applying a pulse rising to the level of the third voltage from a level of a sixth voltage; and
the step of applying a pulse rising to the level of the third voltage and then falling to the level of the fourth voltage includes applying the pulse falling to the level of the fourth voltage from the level of the reference voltage.

5. The method of claim 1, further comprising:
applying an auxiliary reset pulse to the Y electrodes during an auxiliary reset period of another subfield to reset the discharge cells, a maximum voltage of the auxiliary reset pulse being lower than the third voltage.

6. The method of claim 5, wherein the step of applying the auxiliary reset pulse including a step selected from the group consisting of:
applying a pulse rising to a level of a first auxiliary voltage; and
applying a pulse falling to a level of a second auxiliary voltage.

7. The method of claim 1, further comprising:
applying a reference voltage to the address electrodes during the main reset period; and
applying a seventh voltage to the X electrodes while applying a pulse falling to the level of the fourth voltage to the Y electrodes during the second pulse time period.

8. The method of claim 1, further comprising:
applying a seventh voltage to the X electrodes during the address period;
applying a selection pulse having a ninth voltage to the Y electrodes during a selection time that is included in the address period; and
applying an eighth voltage to the Y electrodes during a portion of the address period that is not included in the selection time, wherein the address data signal includes a data pulse having a reference voltage or a tenth voltage, the phase of the data pulse synchronizing with the phase of the selection pulse.

9. The method of claim 1, further comprising:
applying a reference voltage to the address electrodes during the sustain period, wherein the sustain pulse having the first voltage.

10. A plasma display panel device comprising:
a plasma display panel comprising:
a first substrate;
a second substrate facing the first substrate;
X electrodes and Y electrodes disposed between the first substrate and the second substrate; and
address electrodes disposed between the first substrate and the second substrate, the address electrodes crossing the X and Y electrodes, discharge cells being formed at intersections of the address electrodes with the X and Y electrodes; and
a panel driving unit applying a set of driving signals to the plasma display panel to drive the plasma display panel, the set of the driving signals comprising:
a main reset pulse applied to the Y electrodes during a main reset period of a subfield to reset the discharge cells, the main reset pulse comprising:
a first pulse rising to a level of a first voltage and then falling to a level of a second voltage during a first pulse time period; and
a second pulse rising to a level of a third voltage and then falling to a level of a fourth voltage during a second pulse time period, the first voltage being lower than the third voltage;
an address data signal applied to the address electrodes during an address period to select discharge cells to be turned on; and
a sustain pulse alternately applied to the X electrodes and to the Y electrodes during a sustain period to generate a sustain discharge in the selected discharge cells; and

11. The PDP of claim 10, wherein the main reset pulse further includes a preset pulse falling to a level of a fifth voltage during a preset time period that is included in the main reset period.

12. The PDP of claim 11, wherein the magnitude of the fifth voltage is substantially the same as the magnitude of the fourth voltage.

13. The PDP of claim 10, wherein:
the first pulse rises to the level of the first voltage from a level of a reference voltage;
the first pulse falls to the level of the second voltage from the level of the reference voltage;
the second pulse rises to the level of the third voltage from a level of a sixth voltage; and
the second pulse falls to the level of the fourth voltage from the level of the reference voltage.

14. The PDP of claim 10, wherein the set of the driving signals further comprises an auxiliary reset pulse applied to the Y electrodes during an auxiliary reset period of another subfield to reset the discharge cells, a maximum voltage of the auxiliary reset pulse being lower than the third voltage.

15. The PDP of claim 14, wherein the auxiliary reset pulse includes a pulse selected from the group consisting of a first auxiliary pulse rising to a level of a first auxiliary voltage and a second auxiliary pulse falling to a level of a second auxiliary voltage.

16. The PDP of claim 10, wherein:
a reference voltage is applied to the address electrodes during the main reset period; and
a seventh voltage is applied to the X electrodes while applying a second pulse falling to the level of the fourth voltage.

17. The PDP of claim 10, wherein:
a seventh voltage is applied to the X electrodes during the address period;
a selection pulse having a ninth voltage is applied to the Y electrodes during a selection time that is included in the address period;
an eighth voltage is applied to the Y electrodes during a portion of the address period that is not included in the selection time; and
the address data signal includes a data pulse having a reference voltage or a tenth voltage, the phase of the data pulse synchronizing with the phase of the selection pulse.

18. The PDP of claim 10, wherein:
a reference voltage is applied to the address electrodes during the sustain period; and
the sustain pulse having the first voltage.
